(19) United States
(12) Patent Application Publication
(10) Pub. No.: US 2006/0282397 A1
(43) Pub. Date: Dec. 14, 2006

(54) Method and apparatus for pricing and capacity planning under competition, in on demand e-commerce systems with quality-of-service (QOS) guarantees

(76) Inventors: Parijat Dube, Hicksville, NY (US); Laura Wynter, Chappaqua, NY (US)

Correspondence Address: KEUSEY, TUTUNJIAN & BITETTO, P.C., 20 CROSSWAYS PARK NORTH, SUITE 210, WOOBURY, NY, 11797, US

(21) Appl. No.: 11/147,626

(22) Filed: Jun. 8, 2005

(51) Int. Cl. G06Q 40/00

(52) U.S. Cl. 705/400; 705/35

(57) ABSTRACT

There are provided an apparatus, a method, and a computer program product for joint determination of price and capacity. The apparatus includes a price and capacity determination device for jointly determining a price and a capacity for a given item offered for sale by a given e-retailer, based at least upon market competition.

### BACKGROUND

1. Technical Field

The present invention relates generally to e-commerce and, more particularly, to methods and apparatus for pricing and capacity planning under competition, in on demand e-commerce systems with quality-of-service (QoS) guarantees.

2. Description of the Related Art

Appropriately setting prices and performing capacity planning are important tasks for e-commerce firms operating in a competitive environment. These tasks are rendered difficult by the sensitivity of customers to both the price and quality of service offered, and the ease with which customers can inform themselves of the services offered by competing firms in an e-commerce market.

On the service provider-side, IT capacity on demand allows the provider to modulate the capacity of which it avails itself, with very short notice. The quality of service that can be potentially offered by an e-commerce firm depends both on the user demand (use) of the firms' service as well as on the capacity level that the firm has installed or subscribed to from an on demand provider. Some measures of quality, such as delay in service execution, denial of service due to overload, and so forth, are dependent on the amount of load in the system. Thus, there is an inherent interdependence between load, capacity, price and performance. This interdependence can be intelligently exploited for provisioning computing and network resources to satisfy anticipated demand, as well as for defining service models and control mechanisms for resource sharing and scheduling.

Considerable work exists for setting capacity for e-commerce providers. Whereas this line of work may be highly detailed in the composition of the e-commerce provider's web system (e.g., numbers and characteristics of each type of server), competition from other e-commerce providers and its effect on the demand that the provider in question will experience for its service are not considered. Similarly, considerable work exists in pricing for e-commerce; however, that line of prior art does not take into account the capacity planning decision, which is, as mentioned above, intimately linked to the demand for the e-commerce service through the QoS that becomes available.

With respect to tools for intelligent web crawling, the following references are mentioned, the disclosures of which are incorporated by reference herein in their entireties: Pant et al, “My Spiders: Evolve your own intelligent web crawlers”, Autonomous Agents and Multi-agent systems, Vol. 5, pp. 221-229, Kluwer Academic, 2002; and Aggarwal et al., Intelligent Crawling On the World Wide Web with Arbitrary Predicates, in Proceedings International WWW Conference (10), Hong-Kong, 2001.

### SUMMARY

These and other drawbacks and disadvantages of the prior art are addressed by the present invention, which is directed to methods and apparatus for pricing and capacity planning under competition, in on demand e-commerce systems with quality-of-service (QoS) guarantees.

The present invention may be implemented, e.g., as an apparatus, a method, and a computer program product.

According to an aspect of the present invention, there is provided an apparatus for joint determination of price and capacity. The apparatus includes a price and capacity determination device for jointly determining a price and a capacity for a given item offered for sale by a given e-retailer, based at least upon market competition.

These and other objects, features and advantages will become apparent from the following detailed description of illustrative embodiments thereof, which is to be read in connection with the accompanying drawings.

### BRIEF DESCRIPTION OF DRAWINGS

The disclosure will provide details in the following description of preferred embodiments with reference to the following figures wherein:

FIG. 1 is a block diagram illustrating an exemplary client-server environment in which the present invention may be employed, in accordance with the principles of the present invention;

FIG. 2 is a block diagram illustrating an exemplary computer processing system to which the present invention may be applied, in accordance with the principles of the present invention; and

FIG. 3 is a flow diagram illustrating an exemplary market competition based method for determining a price and capacity of an item offered for sale by a plurality of e-retailers.

These and other aspects, features and advantages of the present invention will become apparent from the following detailed description of exemplary embodiments, which is to be read in connection with the accompanying drawings.

### DETAILED DESCRIPTION OF PREFFERED EMBODIMENTS

The present invention is directed to methods and apparatus for pricing and capacity planning under competition, in on demand e-commerce systems with quality-of-service (QoS) guarantees.

Advantageously, the present invention is capable of describing market reactions along with technical characteristics of capacity and quality of service, to enable firms to make more profitable decisions in the face of competition, and to re the uncertainty facing firms in their price-setting and capacity planning choices.

It is to be appreciated that the terms e-commerce system, firm, service provider, and so forth are used interchangeably herein. Moreover, it is to be appreciated that, as used herein, the term “capacity” refers to the potential for holding, storing, or accommodating and in e-commerce systems often refers to the amount of computer resource available; that is, the “capacity” of a computer system may be the number of computers, amount of disk space or memory, and so forth. Further, it is to be appreciated that, as used herein, the phrase “jointly determined” refers to a process that computes quantities of more than one parameter and, in doing so, considers the dependency(ies) between them. Moreover, it is to be appreciated that, as used herein, the term “item” refers to a good, a service, or a combination thereof.

The invention may include and/or involve at least one of the following features: a QoS value, provided by a firm, that is configured to depend upon the capacity of the firm, the load of the firm, market data, and/or usage patterns; and estimation of the market data and/or usage patterns by determining and updating, in real-time, the market context and usage pattern data through intelligent web crawling.

It should be understood that the elements shown in the Figures may be implemented in various forms of hardware, software or combinations thereof. Preferably, these elements are implemented in software on one or more appropriately programmed general-purpose digital computers having a processor and memory and input/output interfaces.

It is to be appreciated that as used herein, the phrase “at least one”, when used to refer to more than one object (e.g., at least one of A and B), refers to at least the following: at least one of A, or at least one of B, or at least one of A and at least one of B.

Embodiments of the present invention can take the form of an entirely hardware embodiment, an entirely software embodiment or an embodiment including both hardware and software elements. In a preferred embodiment, the present invention is implemented in software, which includes but is not limited to firmware, resident software, microcode, etc.

Furthermore, the invention can take the form of a computer program product accessible from a computer-usable or computer-readable medium providing program code for use by or in connection with a computer or any instruction execution system. For the purposes of this description, a computer-usable or computer readable medium can be any apparatus that may include, store, communicate, propagate, or transport the program for use by or in connection with the instruction execution system, apparatus, or device. The medium can be an electronic, magnetic, optical, electromagnetic, infrared, or semiconductor system (or apparatus or device) or a propagation medium. Examples of a computer-readable medium include a semiconductor or solid-state memory, magnetic tape, a removable computer diskette, a random access memory (RAM), a read-only memory (ROM), a rigid magnetic disk and an optical disk Current examples of optical disks include compact disk—read only memory (CD-ROM), compact disk—read/write (CD-R/W) and DVD.

A data processing system suitable for storing and/or executing program code may include at least one processor coupled directly or indirectly to memory elements through a system bus. The memory elements can include local memory employed during actual execution of the program code, bulk storage, and cache memories that provide temporary storage of at least some program code to reduce the number of times code is retrieved from bulk storage during execution. Input/output or I/O devices (including but not limited to keyboards, displays, pointing devices, etc.) may be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

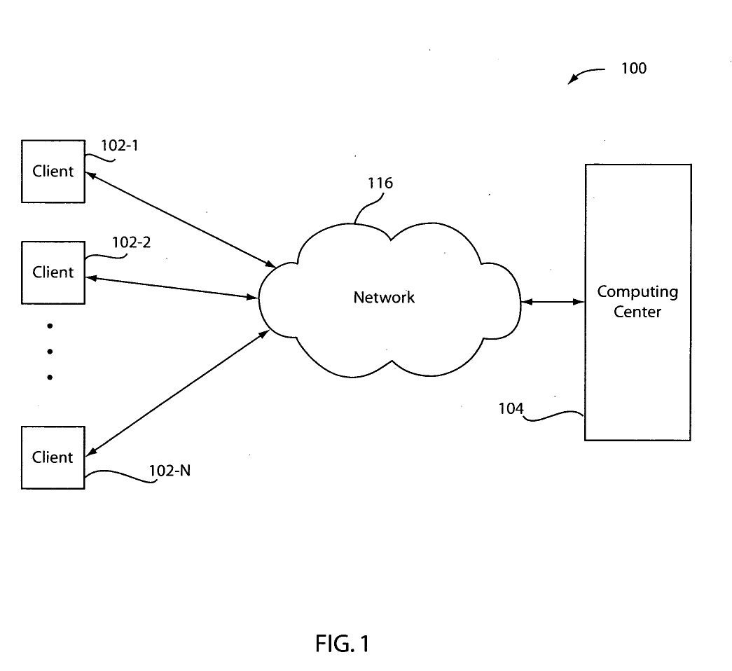

Turning to FIG. 1, an exemplary client-server environment in which the present invention may be employed is indicated generally by the reference numeral 100.

The client-server environment 100 includes a plurality of clients 102-1, 102-2, . . . , 102-N. Each of the plurality of clients is capable of connecting to a computing center 104 via a network 116.

Each of the plurality of clients 102-1 through 102-N and the computing center 104 may be considered to include at least one computer processing system. Of course, the computing center 104 is presumed to have the resources capable of interfacing with and providing pre-specified support and/or information to one or more of the plurality of clients.

For the purposes of the present invention, the plurality of clients represents a plurality of e-retailers that utilize and/or interact with the present invention.

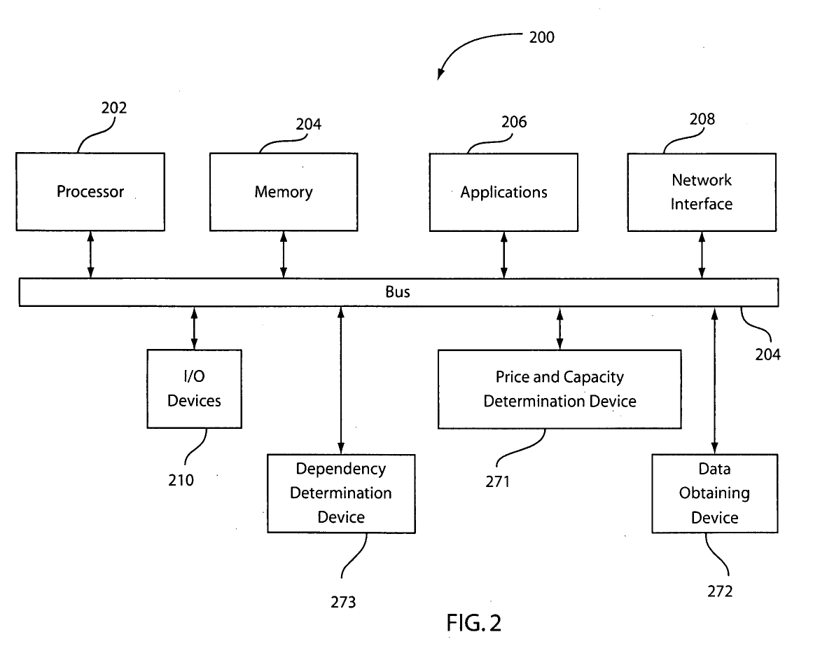

Turning to FIG. 2, an exemplary computer processing system to which the present invention may be applied is indicated generally by the reference numeral 200.

The computer processing system 200 includes one or more processors (hereinafter “processor”) 202, one or more memory devices (hereinafter “memory”) 204, applications 206, and one or more network interfaces (hereinafter “network interface”) 208. The memory 204 may include, but is not limited to, magnetic, optical, disk, RAM, ROM, cache, and so forth. The applications 206 include one or more operating systems and one or more corresponding applications. The network interface 208 may include means and/or structure to interface with wired and/or wireless networks.

The preceding elements of the computer processing system 200 may be found in any of the computing center 104 and the plurality of clients 102-1 through 102-N.

Advantageously, the following elements may also be found in the computing center 104: a price and capacity determination device 271; a data obtaining and processing device 272; and a dependency determination device 273.

The price and capacity determination device 271 determines the price and capacity as described herein. The price and the capacity may be determined, e.g., based upon at least one of market competition, market data and usage patterns data.

The data obtaining and processing device 272 is used, e.g., to obtain at least one of market data and usage patterns data. The data obtaining and processing device 272 may use intelligent web crawling. Moreover, the data obtaining and processing device 272 may further process (including calibrate, etc.) the obtained data and other data for use by the price and capacity determination device 271.

The dependency determination device 273 determines a dependence including but not limited to an implicit dependence, between various parameters considered in the price and capacity determination. The parameters include, but are not limited to, a quality of service (QoS) level, a price, and a capacity. It is to be appreciated that the dependency determination may be made based on, but is not limited to, queuing models and user preference functions.

It is to be further appreciated that while shown as separate elements from the other elements of FIG. 2, the price and capacity determination device 271, the data obtaining and processing device 272, and the dependency determination device 273 may be implemented in a single device, or two or more devices, and may be implemented using other elements of FIG. 2 (e.g., the processor 102, the memory 104, and the applications 106), while maintaining the scope of the present invention.

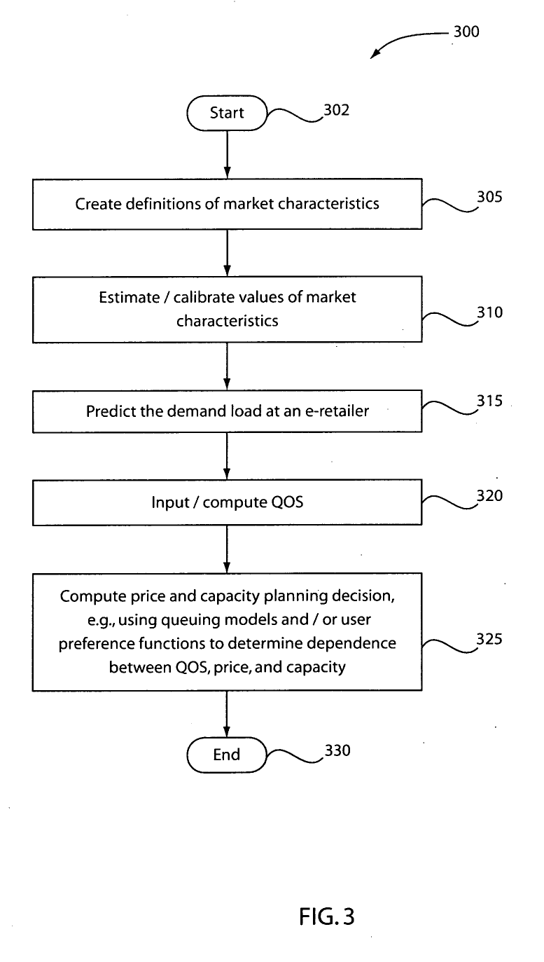

Turning to FIG. 3, a market competition based method for determining a price and capacity of an item offered for sale (hereinafter “item for sale” for short) by a plurality of e-retailers is indicated generally by the reference numeral 300. The item may be a good, a service, or any combination thereof. The determined price and capacity planning decision obtained by the method of FIG. 3 may be used to determine an actual price and corresponding parameters for the item for sale by a given e-retailer.

A start block 302 begins execution of the method, and passes control to a function block 305. The function block 305 creates definitions of one or more pre-specified or dynamically determined market characteristics, and passes control to a function block 310. The market characteristics may include, but are not limited to, user preferences, offerings of competitors, such as competitors' prices, service qualities, other marketing or promotional offers of competitors, market size, competitors' market shares, any information on market growth or shifts, events related to or influencing demand for the item under question, and so forth. In an embodiment, function block 205 may involve the use of a “context-aware” application to obtain market data from the Internet. In another embodiment, function block 305 may involve the use of data mining tools to reduce the quantity of scanned data. Moreover, in yet another embodiment, function block 305 may involve the use of other on-line or off-line means and approaches to create the definitions of the market characteristics. It is to be appreciated that a single embodiment of the present invention may use one or more of the approaches of the preceding embodiments, or one or more other approaches, in any combination, to create the definitions of the market characteristics, while maintaining the scope of the present invention.

The function block 310 estimates/calibrates the values of the market characteristics, and passes control to a function block 315. Function block 310 may estimate/calibrate the market characteristic values based upon real-time Internet data and/or off-line available data. Moreover, function block 310 may involve the estimation of user-preference profiles, which may depend upon price and/or quality of service (QoS) levels offered by the e-retailers, and may involve the estimation of the offerings of one or more competitor e-retailers.

The function block 315 predicts the demand load for the item for sale at the given e-retailer, and passes control to a function block 320.

The function block 320 inputs/computes the desired quality of service (QoS) to be offered by the given retailer, and passes control to a function block 325. With respect to function block 320, it is to be noted that the QoS may depend upon some or all of the price, the capacity, the desired and/or actual QoS, and the predicted load, of the given retailer itself, where possible, and/or one or more competitor e-retailers.

The function block 325 computes the price and capacity planning decision that the given e-retailer should set, and either returns control (not shown) to function block 325 to continually update the determined parameters or passes control to an end block 330. Function block 325 may involve maximizing the utility of the firm in a competitive market model. Queuing models and/or user preference functions may be employed to find the implicit dependence between QoS, price and capacity for use in determining an optimal value and/or combination(s) of values for QoS, price, and/or capacity. Moreover, function block 325 may involve solving for a Nash equilibrium solution. Further, function block 325 may involve another method for computing the price and capacity planning decision based upon at least one or more of the above inputs.

Advantageously, the method of FIG. 3 combines the preceding aspects of competition, price and capacity-dependent QoS, in an on demand IT environment to provide decision aide to service providers in e-commerce.

A description will now be given regarding a preferred embodiment of the present invention. Of course, the present invention is not limited to the specifics of the following embodiment and various other corresponding approaches and elements may be employed in accordance with the present invention, while maintaining the scope of the present invention.

In an embodiment, queuing models are employed together with user preference functions to find the implicit dependence between QoS, price and capacity. This gives the feasible values of QoS for given values of capacity and price for different firms in competition. These QoS values and corresponding capacity and price values are then used, in this example, to solve a game-theoretic optimization problem across the firms, hence offering provider-optimal price and capacity information for each firm.

In this embodiment, we make use of a context-aware platform that crawls/mines the Internet for real-time calibration and updating of the involved market parameters.

In such an exemplary implementation, customers are defined through the use of utility functions, which depend upon prices offered by the service providers as well as the QoS offered by the service providers

In this context, a possible implementation would proceed as follows.

Consider a scenario of K competing service providers. Suppose that the providers distinguish themselves through their prices and the level of QOS they offer to customers, where the QoS is defined as the expected delay to be experience by a consumer. Of course, other definitions of QoS may also be employed in accordance with the present invention, while maintaining the scope of the present invention. Customers may subscribe to the service of any provider, and in this example, are free to switch providers at no cost and at any time.

The context-aware platform that we consider to be in place in this example enables the system to obtain market data relating to relevant customers and competitors. Consider, for example, a utility function that is linear in price and QoS, and a user-specific tradeoff parameter that arbitrates between price and QoS. We refer to that parameter as “a”, and model it here as a random variable taking values in [0,1]. In this context, customers who are more delay-conscious and less price-sensitive are represented by values of “a” close to 0 and the opposite have values close to 1. The probability density function of that parameter, “a”, is calibrated through the use of the web crawling/mining system.

A candidate utility function associated with firm k, for k=1, 2, . . . , K is:
aPₖ+(1−a)Dₖ

where (Pₖ,Dₖ) is the price-delay tuple advertised by firm k. Thus, the customer will join firm i* such that:
aP_{i*}+(1−a)D_{i*}≦aPₖ+(1−a)Dₖ, for all k=1,2, . . . K;

A goal of a firm is to advertise a vector of price and delay such that the revenue of the firm is maximized. Furthermore, the firm should be able to meet the QoS that the firm advertises. This requires the firm to have an appropriate level of capacity. In this example, it is presumed that each firm is seeking to maximize its own profit, that the dynamics can be described through a non-cooperative game, and that the solution to which may be characterized by a Nash equilibrium.

The profit of each firm is defined here as its revenue less its operational costs. Let Rₖ be the revenue of firm k; then Rₖ is a function of the price charged by firm k and the market share of firm k. Let Lₖ, k=1,2, . . . ,K, be the probability that any customer will join firm k. Thus, if the market intensity (measured in terms of arrival rate of customers in the market) is λ, then the market share of firm k is λLₖ. Let ξₖ be the per-unit capacity operational cost. Then, the total operational cost can be written as a function of cₖ and bₖ as S(cₖ,bₖ).

Thus, in this example, firm k seeks to maximize the profit function Rₖ(Pₖ,Lₖ)−S(cₖ,bₖ).

Let P, D and C be the vectors of the price, capacity and delay of the K firms. We can express Lₖ as a function of P and C. To do so, one can first express delay Dₖ as a function of capacity and market share, for example, by a simple M/M/1 queuing relation:
Dₖ=1/(μcₖ−λLₖ),

where cₖ is the capacity that firm k will need to provide expected delay Dₖ and 1/μ is the mean service time of a packet.

Observe that Lₖ in itself is a function of P and D from (1). Let us write Lₖ as fₖ(P,D) where P and D are vectors with P={Pₖ,k=1, . . . K} and D={Dₖ,k=1, . . . ,K}. The function fₖ(P,D) may be calibrated through use of the market mining and web crawling feature.

Thus, in this illustrative example, the delays Dₖ for the firms are characterized as solutions to following set of K fixed point equations:

$$[ \begin{matrix}{D}_{1} & 0 & ⋯ & 0 \\ 0 & {D}_{2} & ⋯ & 0 \\ ⋮ & ⋮ & ⋰ & ⋮ \\ 0 & 0 & ⋯ & {D}_{k}\end{matrix} ] [ \begin{matrix}{μ c}_{1} - λ {f}_{1} ( P , D ) \\ {μ c}_{2} - λ {f}_{2} ( P , D ) \\ ⋮ \\ {μ c}_{k} - λ {f}_{k} ( P , D )\end{matrix} ] = [ \begin{matrix}1 \\ 1 \\ ⋮ \\ 1\end{matrix} ]$$

The solution gives delay as a function of price and capacity decisions, P and C. Since the market share is a function of price and delay one can write the market share and, hence the revenue, as a function of price and capacity. Thus, in this example, the firm's optimization problem reduces to finding Pₖ and cₖ so as to maximize the revenue function:
Rₖ(Pₖ,cₖ)−S(cₖ,bₖ)

Periodically, the context-aware crawler/miner updates the parameters and the computations are redone to determine potentially new market shares, QoS levels, and price/capacity decisions for the firms.

Having described preferred embodiments of a system and method (which are intended to be illustrative and not limiting), it is noted that modifications and variations can be made by persons skilled in the art in light of the above teachings. It is therefore to be understood that changes may be made in the particular embodiments disclosed which are within the scope and spirit of the invention as outlined by the appended claims. Having thus described aspects of the invention, with the details and particularity required by the patent laws, what is claimed and desired protected by Letters Patent is set forth in the appended claims.

What is claimed is:

1. An apparatus for joint determination of price and capacity, comprising a price and capacity determination device for jointly determining a price and a capacity for a given item offered for sale by a given e-retailer, based at least upon market competition.

2. The apparatus according to claim 1, wherein the given item is any one of a good, a service, or a combination thereof.

3. The apparatus according to claim 1, further comprising a system for obtaining at least one of market data and usage patterns data using intelligent web crawling, and wherein the price and the capacity are determined based upon the at least one of the market data and the usage patterns data.

4. The apparatus according to claim 3, wherein the system determines and updates, in real-time, the market data and the usage patterns data.

5. The apparatus according to claim 1, wherein the market competition, for the given e-retailer, is at least represented by a quality of service (QoS) level.

6. The apparatus according to claim 5, wherein the QoS level, for the given e-retailer, is dependant upon at least one of the capacity, a load, the market data and usage patterns data.

7. The apparatus according to claim 6, further comprising a dependency determination device for determining a dependence between the QoS level, the price, and the capacity, for the given e-retailer, based upon at least one of queuing models and user preference functions.

8. A method for joint determination of price and capacity, comprising the step of jointly determining a price and a capacity for a given item offered for sale by a given e-retailer, based at least upon market competition.

9. The method according to claim 8, wherein the given item is any one of a good, a service, or a combination thereof.

10. The method according to claim 8, further comprising the step of obtaining at least one of market data and usage patterns data using intelligent web crawling, and wherein the price and the capacity are determined based upon the at least one of the market data and the usage patterns data.

11. The method according to claim 10, further comprising the steps of determining and updating the market data and the usage patterns data in real-time.

12. The method according to claim 8, wherein the market competition, for the given e-retailer, is at least represented by a quality of service (QoS) level.

13. The method according to claim 12, wherein the QoS level, for the given e-retailer, is dependant upon at least one of the capacity, a load, the market data and usage patterns data.

14. The method according to claim 12, wherein said determining step comprises the step of determining a dependence between the QoS level, the price, and the capacity, for the given e-retailer, based upon at least one of queuing models and user preference functions.

15. A computer program product comprising a computer usable medium including computer usable program code for joint determination of price and capacity, said computer program product including computer usable program code for jointly determining a price and a capacity for a given item offered for sale by a given e-retailer, based at least upon market competition.

16. The computer program product according to claim 15, wherein the given item is any one of a good, a service, or a combination thereof.

17. The computer program product according to claim 15, further comprising computer usable program code for obtaining at least one of market data and usage patterns data using intelligent web crawling; and wherein the price and the capacity are determined based upon the at least one of the market data and the usage patterns data.

18. The computer program product according to claim 17, further comprising computer usable program code for determining and updating the market data and the usage patterns data in real-time.

19. The computer program product according to claim 15, wherein the market competition, for the given e-retailer, is at least represented by a quality of service (QoS) level.

20. The computer program product according to claim 19, wherein the QoS level, for the given e-retailer, is dependant upon at least one of the capacity, a load, the market data and usage patterns data.

21. The computer program product according to claim 19, wherein said computer usable program code for determining the price and the capacity comprises computer usable program code for determining a dependence between the QoS level, the price, and the capacity, for the given e-retailer, based upon queuing models and user preference functions.
